(19) United States
(12) Patent Application Publication
(10) Pub. No.: US 2014/0199578 A1
(43) Pub. Date: Jul. 17, 2014

(54) FLEXIBLE ALKALINE BATTERY

(71) Applicant: New Jersey Institute of Technology, Newark, NJ (US)

(72) Inventors: Somenath Mitra, Bridgewater, NJ (US); Zhiqian Wang, Kearny, NJ (US)

(21) Appl. No.: 14/156,270

(22) Filed: Jan. 15, 2014

Related U.S. Application Data
(60) Provisional application No. 61/752,929, filed on Jan. 15, 2013.

(51) Int. Cl. H01M 4/583; H01M 10/28; H01M 2/16; H01M 6/04

(52) U.S. Cl. CPC H01M 4/583; H01M 6/04; H01M 10/287; H01M 2/1653
USPC 429/127

(57) ABSTRACT

This invention presents the development of flexible battery especially primary and secondary alkaline batteries. Nano carbons, in particularly carbon nanotubes are implemented in conductive polymers to develop flexible electrodes. Polymer separators that can withstand high pH and serve the purpose of electrolyte storage is used to enhance performance. The relatively inexpensive multiwall nanotubes represent are effective ingredients in development of flexible electrodes.

This application claims the benefit of U.S. Provisional Patent Application Ser. No. 61/752,929 filed Jan. 15, 2013.

This invention was made with government support under Grant Number RC2 ES018810 awarded by the National Institute of Environmental Health Sciences (NIEHS). The government has certain rights in the invention.

This invention relates to a flexible primary and secondary alkaline batteries, more particularly, to flexible alkaline batteries having multiwalled carbon nanotubes (MWCNTs) enhanced composite electrodes and polyvinyl alcohol (PVA)-poly (acrylic acid) (PAA) copolymer separator.

### BACKGROUND OF THE INVENTION

As the development of mobile electronic devices proceeds, there is a greater and greater demand for new flexible and versatile power sources such as flexible batteries, which can take the places of the traditional bulky batteries on many occasions. Increasing interest for flexible/bendable electronics requires the development of flexible energy storage devices which can be implemented in products such as smart cards, memory chips, radio frequency identification tags as well as pharmaceutical and cosmetic transdermal delivery patches. Both primary and secondary batteries are being developed to meet the requirement of new electronics which have been reducing in size and increasing in mobility. Commercially available printing techniques including stencil printing and ink-jet print are also used for production of thin film devices. The production costs of such power sources can be relatively low, and they can be manufactured by cost-effective printing techniques that are compatible with printable electronics. Different types of flexible batteries are being developed including flexible zinc carbon batteries, primary alkaline batteries and secondary lithium ion batteries. In many systems secondary batteries which are more durable and eco-friendly turn out to be more favorable than primary batteries. Flexible lithium-ion batteries with high output voltage and rechargeability have been the most widely studied flexible secondary battery system. However, the relatively higher cost and safety issues are still problems to overcome. Compared to organic electrolyte, aqueous systems are less toxic and non-flammable, making them safer choices.

Recent patents and publications have focused on the development of different aspects of the flexible battery manufacturing processes, including design of the cells, current collectors, electrodes ink as well as electrolyte formulations.

There have been reports on secondary alkaline batteries, which use MnO₂ as cathode active material, Zn as anode active material, alkaline solution as electrolyte and a separator between the electrodes just like their primary counterparts. Unlike lithium-ion batteries which have to be charged before the first use, secondary alkaline batteries can be used just out of package. Like zinc-carbon cells, they are suitable for low drain or intermittent devices, and costs of secondary alkaline batteries are low. Flexible primary alkaline batteries have been reported in recent years; however, none research has been reported on flexible secondary alkaline batteries.

Alkaline batteries use MnO₂ as cathode active material with binder typically poly ethylene oxide (PEO) and conductive additives such as graphite. Zinc together with inhibitor and binder is mixed to form the anode material. A separator, often polyvinyl film or other films, is placed between the electrodes. The electrodes and separator are soaked in KOH electrolyte. The primary alkaline battery is more durable under heavy load than the zinc carbon battery. Another advantage is that, unlike the lithium battery, an alkaline battery is more eco-friendly, for organic solvent is neither used during the fabrication, nor in the electrolyte.

Polyvinyl alcohol (PVA) and poly (acrylic acid) (PAA) have been reported to be used for polymer gel electrolyte or separator in flexible battery; others reported the fabrication of such films but didn't apply them into batteries. With high flexibility and good ionic conductivity, such polymer film can be promising in battery fabrications.

Thus there remains a need for a less expensive flexible primary and secondary alkaline batteries.

### SUMMARY OF THE INVENTION

New flexible primary and secondary alkaline batteries enhanced with MWCNTs have now been developed. MWCNTs were shown to create conductive network more effectively than graphite while held electrolyte effectively. The oxidative functionalization of CNTs increased the surface resistance of the electrode composite and decreased the electrochemical performance, while purification removed the impurities, changed the surface characteristics and hence brought improvement. To keep balance between performance and flexibility, amount of binder and CNTs can be controlled. The relatively inexpensive raw MWCNTs represent an advantageous alternative to significantly more expensive SWCNTs or less effective graphite in composite MnO₂ cathode. The application of PVA-PAA copolymer, which not only separates the electrodes but also serves as electrolyte storage, ensures the flexibility of the battery without significantly compromising performance.

Flexible alkaline batteries of the invention with MWCNT electrodes and copolymer separators, and optimized ratio of CNTs considering both the flexibility and discharge performance is described in more detail below. In addition, varied types of conductive additives, including different MWCNTs, were added and tested. With an optimized formulation, the discharge performance under mechanic stress has been investigated.

Thus, the invention relates to a flexible a battery comprising nanocarbon enhanced composite electrodes consisting of an anode and a cathode and a separator.

In an embodiment of the invention, the invention relates to a flexible battery which is an alkaline battery.

In a particular embodiment, the flexible battery comprises carbon nanotubes (CNT enhanced composite electrodes consisting of an anode and a cathode and a polyvinyl alcohol (PVA)-poly (acrylic acid) (PAA) copolymer separator.

In some embodiments, the CNTs are purified.

The batteries of the invention may be either primary or secondary alkaline batteries. In particular embodiments of the invention relating to primary alkaline batteries, the cathode may comprise electrolytic manganese dioxide powder, polyethylene oxide and multiwalled carbon nanotubes and the anode may comprise zinc, zinc oxide, conductive additive, bismuth III oxide and polyethylene oxide.

In particular embodiments of the invention relating to secondary alkaline batteries, the cathode may comprise electrolytic manganese dioxide powder, magnesium oxide, polyethylene oxide and one or more conductive additives selected from the group of synthetic, multiwalled carbon nanotubes, and carbon black and the anode may comprise zinc powder, zinc oxide powder, methyl cellulose, Bismuth (III) oxide inhibitors, and one or more conductive additives selected from the group of synthetic, multiwalled carbon nanotubes, and carbon black.

### BRIEF DESCRIPTION OF THE DRAWINGS

So that those having ordinary skill in the art will have a better understanding of how to make and use the disclosed systems and methods, reference is made to the accompanying figures wherein:

FIG. 1 shows the fabrication of a flexible battery: a) anode; b) cathode; c) assembled cell; d) structure of the battery; e) bending conditions;

FIG. 2 shows SEM images of electrode materials for a primary battery: (a) cathode with raw CNTs; (b) cathode with purified CNTs; (c) cathode with functionalized CNTs; (d)zinc anode;

FIG. 3 shows 1 ohm constant resistance discharge curves of primary batteries with different conductive additives (in Swagelok cells);

FIG. 4 shows a) Batteries with different amount of purified CNTs in cathodes (in Swagelok cells); b) cathode cracking at high CNT percent;

FIG. 5 shows effects of PEO binder and CNTs in anode (in Swagelok cells);

FIG. 6 shows discharge curves under different currents;

FIG. 7 shows discharge pattern under bending conditions;

FIG. 8 shows an LED demo with flexible alkaline batteries;

FIG. 9 shows SEM images of (a) cathode with graphite and carbon black (b) cathode with MWCNTs; (c) cathode with carbon black and MWCNTs; (d) MWCNTs in anode;

FIG. 10 shows a discharge and charge curve of a secondary alkaline cell;

FIG. 11 shows cells with different types of carbon additives in the cathode;

FIG. 12 shows cells with different amount of purified CNTs and 2% carbon black in cathode;

FIG. 13 shows cells with different types of CNTs (2%) in anode;

FIG. 14 shows cells with different amount of CNTs in anode;

FIG. 15 shows cells with different Zn:ZnO ratio in anode;

FIG. 16 shows (a)anode material after 30 cycles; (b) anode material with higher amount of gelling agent; SEM image of lighter part of anode; (d) SEM image of darker part of anode;

FIG. 17 shows cells with different amount of methyl cellulose and glass fiber separator;

FIG. 18 shows cycles under different bending conditions;

FIG. 19 shows flexible secondary alkaline batteries powering LED lights.

### DETAILED DESCRIPTION OF THE INVENTION

Nano materials now are providing new ways for the further development of the flexible batteries. Carbon nanotubes (CNTs) have shown many unique characteristics including the high conductivity, mechanical properties, kinetic properties, large surface areas and so on, making themselves promising materials for flexible batteries and thus draw considerable scientific attention. CNTs are being added into electrode materials to increase conductivity. Carbon nanotubes have been used as the conductive additive in flexible thin film batteries. Carbon nanotube films can also serve as lightweight flexible current collector for composite electrodes. However, most of the research has been based on the more expensive singlewalled carbon nanotubes (SWCNTs); application of multiwalled carbon nanotubes (MWCNTs) has been relatively rare though MWCNTs are considered to be metallic with gaps or significant variations in electronic density of states averaged out, and much cheaper than the SWCNTs.

The multiwalled CNTs were found to be more effective than graphite. Although with higher dispersibility, carboxylated CNTs appeared to increase the surface resistance of the electrode and decrease the electrochemical performance; while purified CNTs performed even better than raw CNTs due to the possible surface modification and removal of impurities, without significant surface resistance increase. The multiwalled nanotubes, which cost much less than single walled carbon nanotubes, appear to be effective alternative to graphite in flexible composite electrodes. The purification process of CNTs before application can further improve the performance, while a flexible copolymer separator not only enables the flexibility but also serves as electrolyte storage.

Both primary and secondary flexible alkaline batteries have been fabricated as described more completely below.

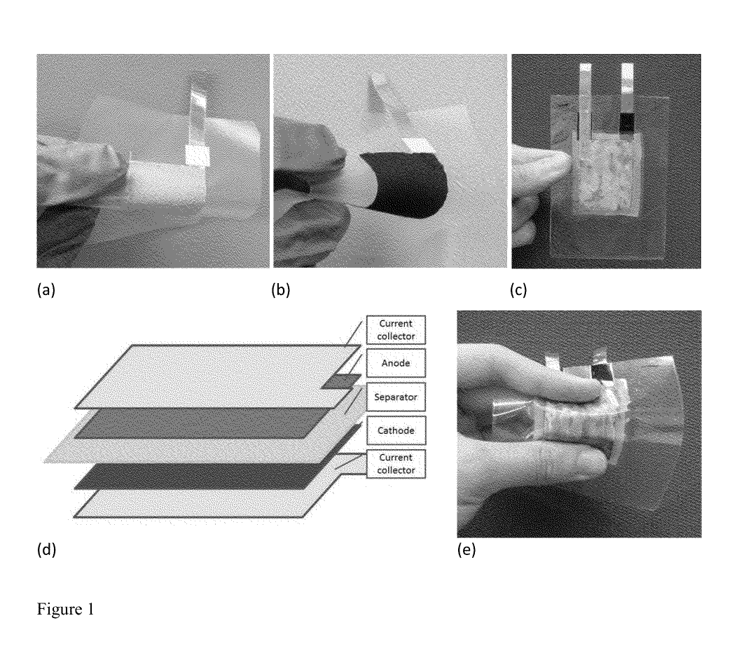

The structure of flexible battery of the invention is shown in FIG. 1. The flexible separator, which is not electric conductive but ionic conductive, lies between the flexible electrodes coated on flexible substrates. The pasted electrodes also showed desirable flexibility.

In work relating to primary alkaline batteries, an embodiment of the flexible electrodes of the invention was prepared by casting the electrode slurries onto the current collector and pasted directly onto the substrate coated with silver ink. Before casting the electrode material, the carbon tape was stuck to the adhesive side of polyethylene terephthalate PET film, coated with ethylene vinyl acetate copolymer (EVA) resin. The typical electrode area of a flexible battery was 4 cm×3 cm. The strips of copper foil stuck to the current collector served as electrode tabs. The electrodes are bendable as shown in FIG. 1.

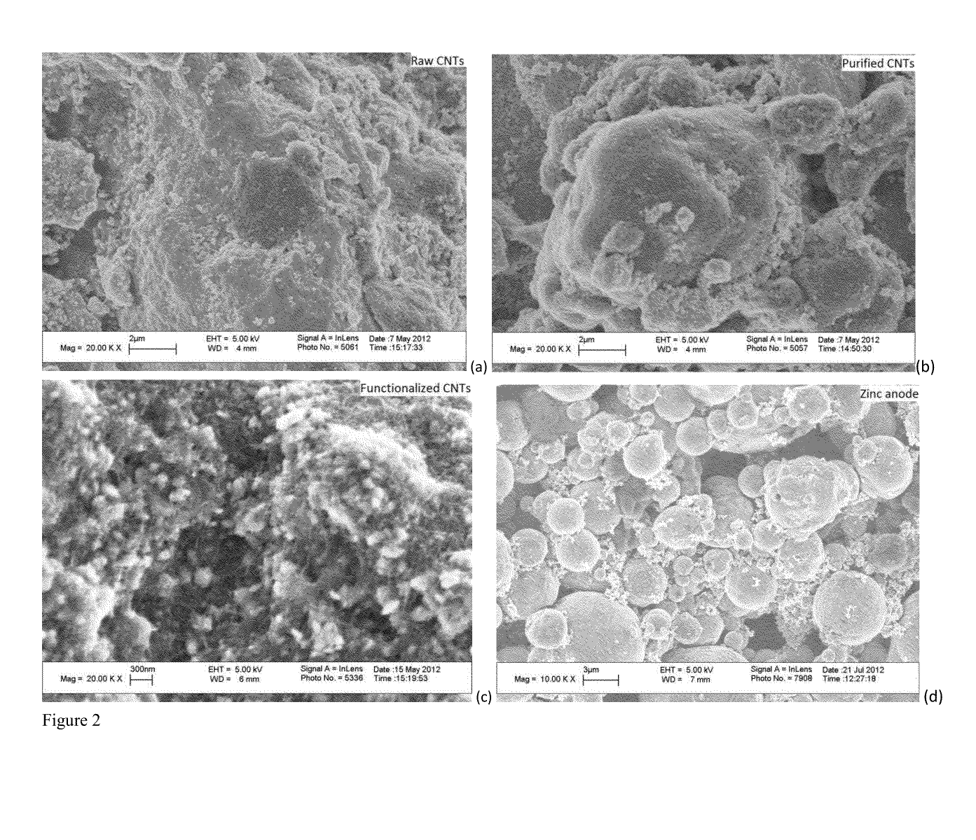

Since the conductivity of MnO₂ in cathode is poor, different types and amounts of conductive additives were added into cathode to reduce the cell internal resistance. Different carbon conductive additives were tried and the performance of the batteries was compared. The surface resistance of the cathode materials had been shown in Table 1 and SEM images of the electrode materials are shown in FIG. 2.

TABLE 1
Surface resistance of cathode materials with different conductive additives

| Conductive | | Functionalized | | |
|---|---|---|---|---|
| additive | Graphite | CNTs | Purified CNTs | Raw CNTs |
| Surface | 30.5 kΩ | 5.40 kΩ | 1.88 kΩ | 0.540 kΩ |
| Resistance | | | | |

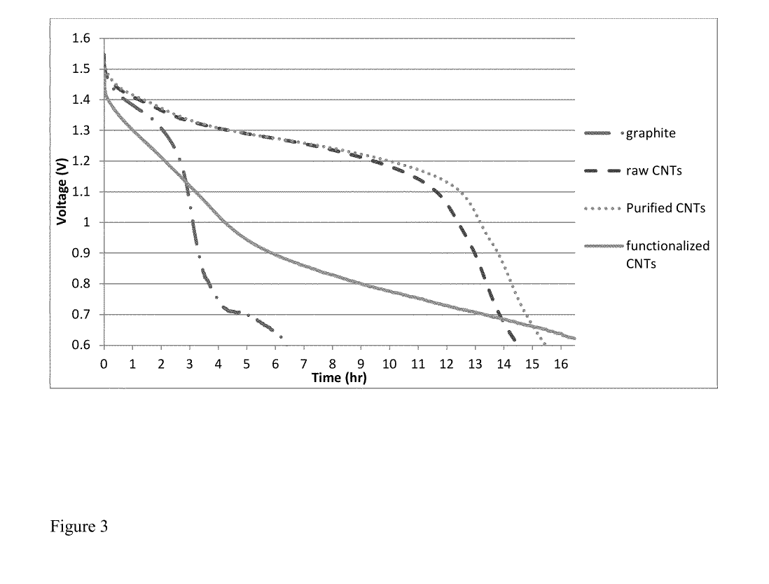

The application of raw CNTs instead of graphite brought the resistance down from 30.5KΩ to 0.54KΩ. FIG. 3 shows the discharge performance of batteries in Swagelok cells modes. This decrease in the cathode resistance can be attributed to the fact that due to the smaller sizes of CNTs, they can create conduction network more effectively compared with graphite, bringing better performance. These results again advocate that CNTs have obvious advantages for electrode applications compared with graphite. In addition, alkaline metal cations are believed to locate on top of the phenyl group of the CNTs, resulting cation-π interaction, no matter the type or diameter of the CNTs. When potassium cations stay on CNT surfaces, the CNTs become positively charged. The electric repulsion between CNTs might inhibit the agglomeration.

The hollow structures and low densities allow CNTs in electrodes to behave like sponge and hold the electrolyte. When this property might enhance the battery performance, however, it may also cause problems, which shall be discussed later.

As shown in FIG. 3, purified CNTs brought improvement as a conductive additive even more than raw CNTs, though the electrode resistance was higher. One of the possible explanations may be that the purification process removed the metallic impurities which may influence the chemical reactions, as well as the graphitic nanoparticles, amorphous carbon. Another explanation might be that holes and defects were left when the metallic particles on the tube surface were removed.

Electrochemical pretreatment of carbon nanotubes are able to change the electronic properties, making surface porous. Under some conditions treatment of nitric acid may also generate oxygenic groups, making it more hydrophilic and to some extent enhanced the dispersion of CNTs in the basic electrolyte as functionalization. Although there have been reports that the surface oxidation treatment may enhance the electronic conductivity of CNTs and their composites, the functionalized CNTs behaved poorer compared with raw CNTs. A possible explanation may be that the oxidative treatment created defects on the CNT surface and, therefore, it caused an increase in the resistance. The deeper the treatment was, the poorer the conductivity would be. The conditions of purification were less harsh than those of functionalization, hence the oxygen content of the CNTs changed less when purification, according to the EDX data (Table 2) of the CNTs. For zinc-carbon flexible batteries, which has acidic or neutral electrolyte, the electrode with functionalized CNTs lasted 1.5 times longer as the graphite electrode, when in alkaline batteries the electrode with functionalized CNTs lasted 2.8 times longer.

TABLE 2
EDX results for CNTs

| Element | | | |
|---|---|---|---|
| weight % | Raw CNTs | Purified CNTs | Functionalized CNTs |
| C | 94.55 | 94.94 | 92.02 |
| O | 1.36 | 2.59 | 6.85 |
| Ni | 3.74 | 2.47 | 1.13 |
| Fe | 0.34 | 0 | 0 |

Although the total performance was compromised by the higher resistance, the functionalized CNTs do have better dispersion than raw CNTs.

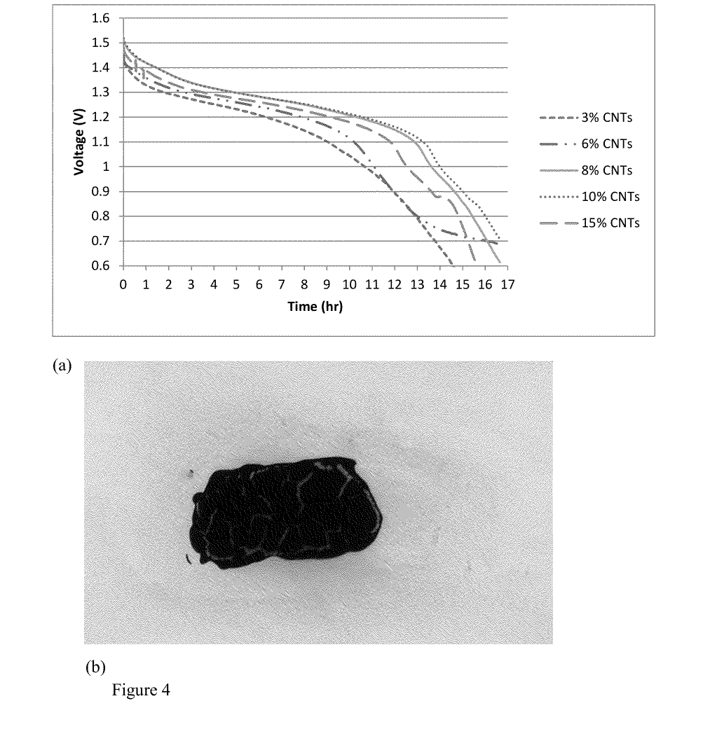

Increasing the concentration of CNTs resulted in a higher operation voltage and higher discharge capacity. However the amount of active material decreased, which may reduce the capacity of the cell (FIG. 4). In addition, due to the high surface area the CNTs need more binder to keep them together. As the amount of CNTs increased, the electrode materials became more and more fragile, which compromised the flexibility. Electrodes with more than 10% CNTs were fragile and easy to disintegrate. As mentioned before, the hollow structures allowed CNTs in electrodes to hold the electrolyte and enhance the discharge performance, it might also bring problems: the electrodes swelled as they soaked up water, and they shrinked as they dried out, and cracked like soil when there was insufficient binder to hold it (FIG. 4b). That could explain why Electrodes with 15% CNTs performed even worse. To avoid this and maintain electrode flexibility, more binder was required, only to decrease the conductivity and chemical reactivity. Similar things happened in anode.

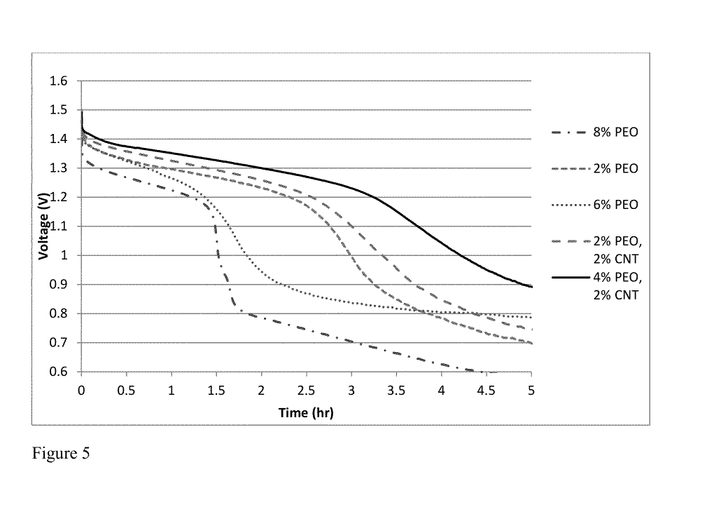

Because, as discharge goes on, zinc is consumed, generating zinc oxide and the internal resistance increases, excess amount of zinc was applied in anode to maintain the electrode conductivity. Gas evolution in alkaline batteries has always been a problem. An increase in ZnO concentration, which is often added additionally into anode or electrolyte to hinder zinc corrosion, or a decrease in KOH concentration decreases hydrogen generation. Besides, organic compounds or metals as Bi, Pb, Al can be added into the anode, to hinder the anodic corrosion. The organic inhibitors and metal oxides inhibitors are nonconductive, and together with PEO and the zinc oxide generated during the reaction, they increase the anode resistance. In order to overcome the resistance, small amount of CNTs were added into the anode. In most cases, the more binder in the anode, the higher the flexibility, the poorer the conductivity and the discharge performance. In other cases when there was insufficient binder, the anode was susceptible to cracking as cathode in FIG. 4b, causing a decrease in the discharge performance. That was the reason why the discharge performance increased when the PEO ratio increased (FIG. 5). Effects of binder amounts in anode had also been shown in FIG. 5 with 6% graphite in cathode.

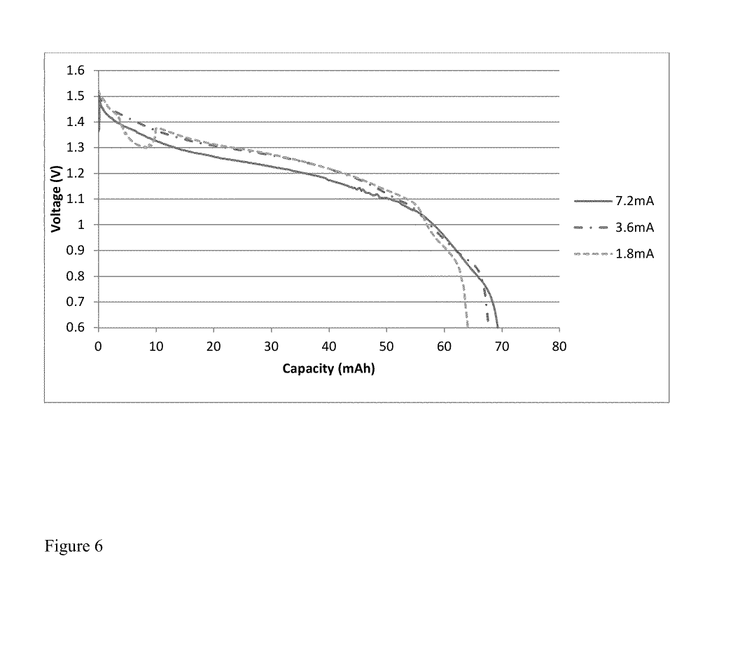

The capacity of a flexible battery obtained for the cathode with 8% purified CNTs (283 mAh/g) corresponded to the utilization of 92% of the theoretical capacity of MnO₂ (308 mAh/g) under a 3.6 mA constant current discharge with a cut off voltage 0.8V. However, under bending conditions the cathode efficiency can be lower than that. Discharge performances at different discharge rate have been shown in FIG. 6.

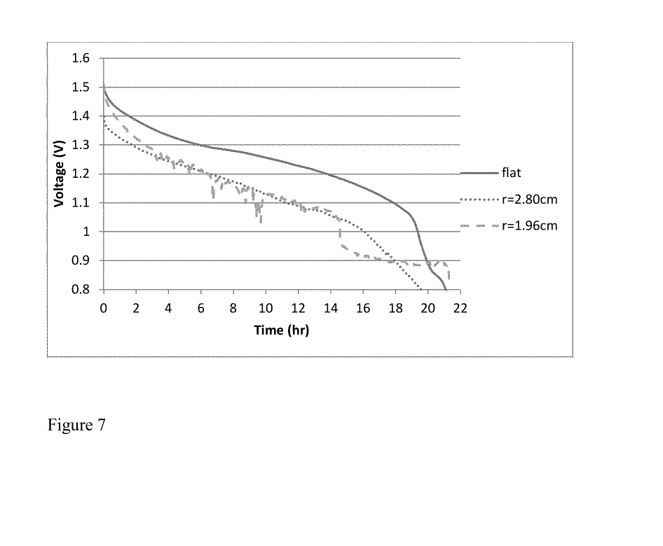

Discharge tests under bending conditions revealed that the batteries remained functional (FIG. 7). The electrodes, substrate and separator all show decent flexibility. The PVA-PAA copolymer film separator had better flexibility than glass fiber or filter paper separator and remained stable in the basic environment. A thicker separator holds more electrolyte when compromised thickness and flexibility. According to our experiment result, 1 g dry separator could absorb and hold 2.44 g electrolyte. However, the discharge voltage was lower and voltage fluctuations were observed. In our opinion, the bending performance can be further improved by further optimization of the separator and by the utilization of more effective sealing system.

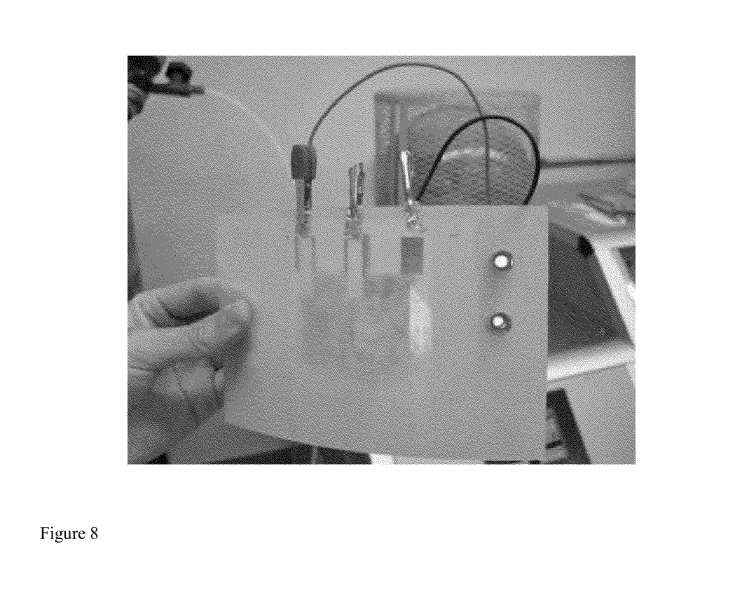

Two batteries connected in serial can light up led lights as shown in FIG. 8.

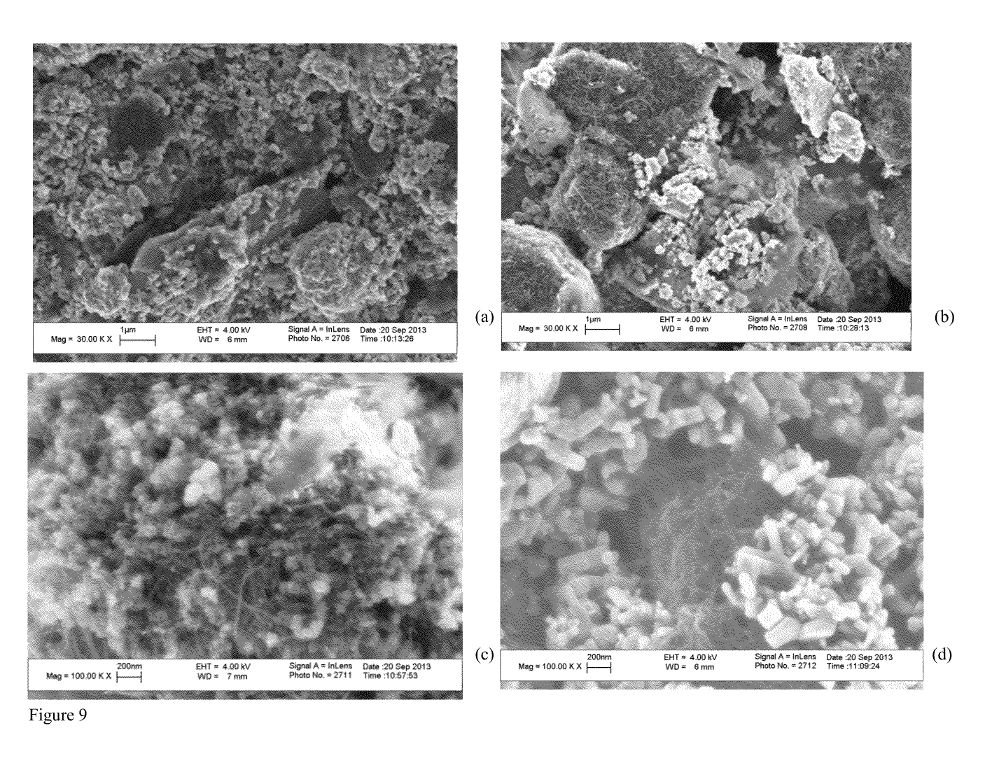

In work relating to secondary or rechargeable alkaline batteries of the invention, different flexible cathodes were fabricated. FIG. 9 a-c shows SEM images of the different cathodes. Table 3 shows the EDX data of different carbon nanotubes.

TABLE 3
EDX data of different MWCNTs

| | | | Fe | Ni |
|---|---|---|---|---|
| CNTs | C weight % | O weight % | weight % | weight % |
| MWCNTs-raw | 96.57 | 1.34 | 0.19 | 1.90 |
| MWCNTs-purified | 97.66 | 0.82 | — | 1.52 |
| MWCNTs-COOH | 86.81 | 13.19 | — | — |

Acid functionalization introduced more oxygen into the CNTs in the form of COOH groups. The purification in dilute acids was not harsh and generated few defects. These conductive additives were added into cathode to reduce the internal resistance.

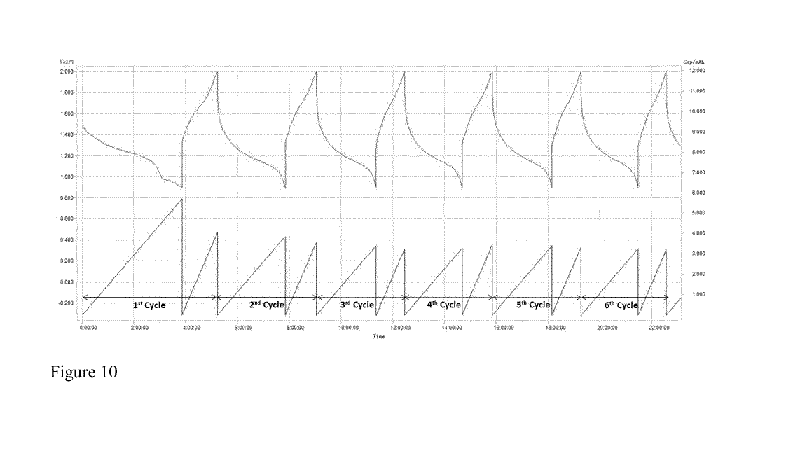

The constant current discharge and charge curve of an alkaline cell is shown in FIG. 10. This typical cell contained 6% CNTs and 2% carbon black as conductive additives in cathode, and zinc, zinc oxide as well as 2% CNTs in anode, with a copolymer separator between them.

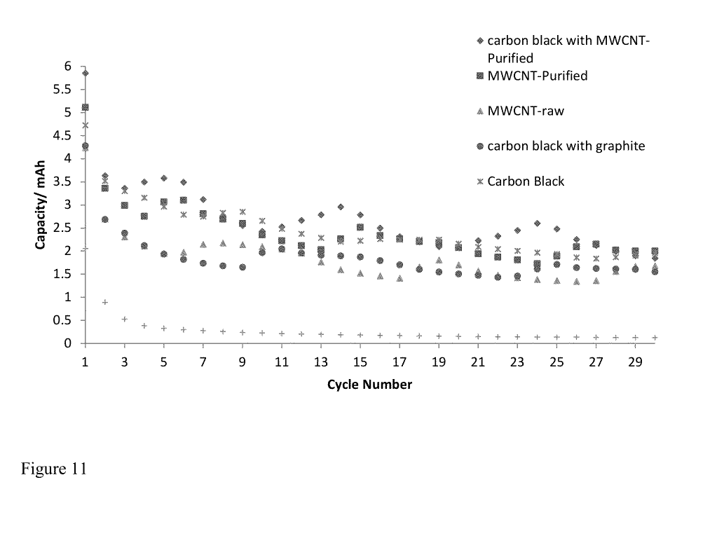

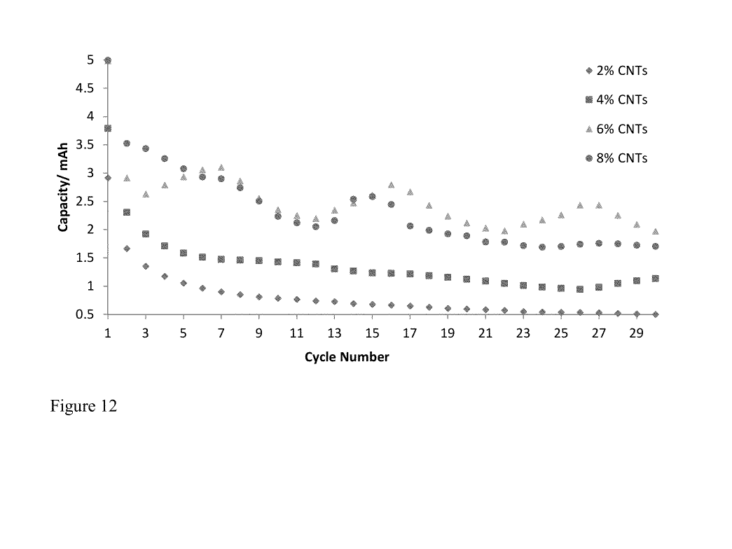

Performances of different cells with different carbons are shown in FIG. 11. Graphite which has been extensively used together with carbon black in rechargeable alkaline batteries showed lower performance than the CNTs. The replacement of graphite by MWCNTs improved the cell performance. The purification of MWCNTs removed impurities which might have hindered the electrochemical reactions and hence enhanced cell performance even further. However, unlike lithium-ion batteries in which case lithium ions could be stored in the defects of CNTs so that functionalization would increase the capacity, the functionalized CNTs showed lower performance due to the defects and lower conductivity; even in the first discharge, the functionalized CNTs showed lower capacity, which was the same case as in primary batteries due to higher electrode resistance. Rechargeability also turned out to be poor. As has been reported in our previous works, flexible battery electrode becomes fragile as more conductive additives are added, and the discharge performance may decrease.^{[16]} Carbon black electrode was also found to be more fragile than their MWCNT counterparts. Our experiment results indicated that cathode with 6% purified MWCNTs and 2% carbon black showed both good performance and decent flexibility (FIG. 12). Electrode with 8% purified MWCNTs and 2% carbon black showed similar performance but capacity faded faster; the electrode flexibility was also lower.

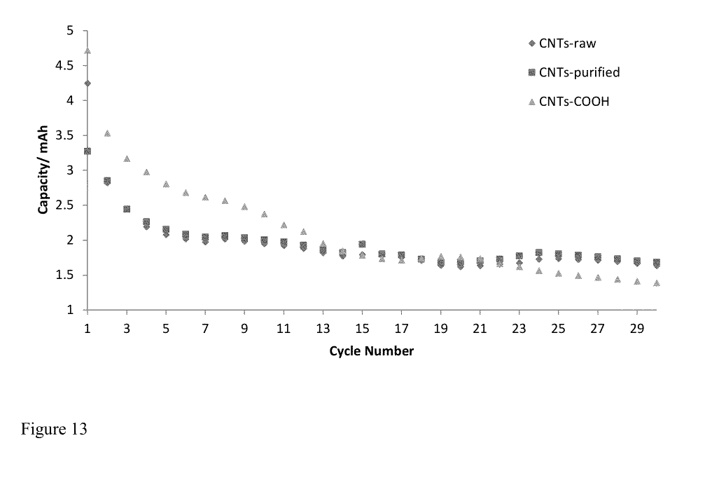

In addition, flexible anodes were fabricated. The CNTs dispersed well with the micronized zinc and bridged the conductive particles. Zinc was oxidized to zinc oxide during discharge. Other composites such as PEO, methyl cellulose and Bi₂O₃ are non-conductive. In order to maintain the anode conductivity MWCNTs were added into anode. Three different MWCNTs were tried, as shown in FIG. 13. Unlike the case in cathode, the purification of MWCNTs provided little improvement. The most significant reason for purification would be hindering gassing. MWCNT-COOH showed better performance during the first 10 cycles; however the capacity faded much faster. It is concluded that during the beginning cycles with sufficient zinc and electrolyte, the lower conductivity of MWCNT-COOH was compromised by the high conductivity of zinc metal. During the following cycles when zinc was consumed or coated zinc oxide, the electrode conductivity dropped, MWCNT-COOH would not be as efficient conductive additive as the other CNTs.

The combination of purified MWCNTs and carbon black showed best performance. CNTs and carbon black are more effective as conductive additive than graphite due to better dispersibility. Nanotubes were dispersed together with carbon black in the active cathode material; the latter filled into the small gaps better and connected to conductive networks formed by MWCNT bundles. The unique shape of CNTs maintained the integrity of the electrode better during bending. It is inferred here that carbon black and CNTs both dispersed among MnO₂. The unique shape of CNTs helped a CNT to bridge the carbon black particles and other CNTs, forming conductive branches and networks. In another test the cathode with only carbon black as its conductive additive turned out to be fragile and less favorable for bending. Compared to primary cells, the performance and active material utilization was lower, which can be attributed to the higher amount of non-conductive agents that were added to the electrode.

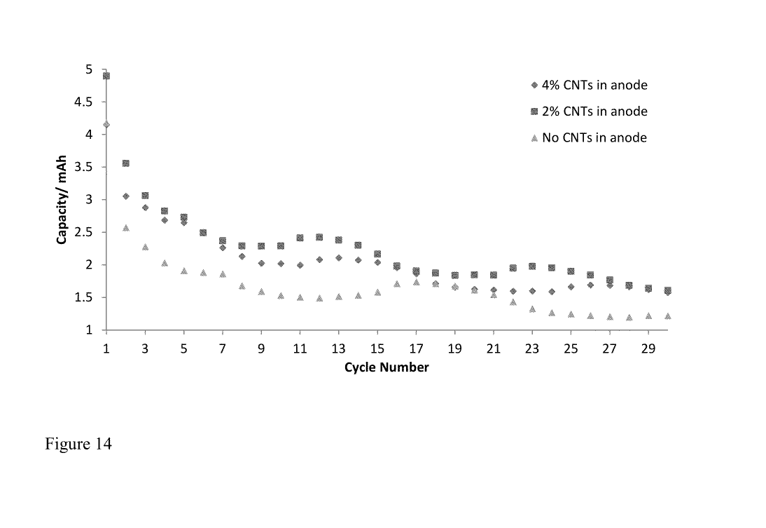

A rise of CNT amount in anode would compromise the electrode flexibility just like the case of cathode. According to our test 2% MWCNTs in anode would balance the performance and flexibility (FIG. 14). Without CNTs the cell capacity faded fast. MWCNTs might also work as gelling agent or provide channels for electrolyte.

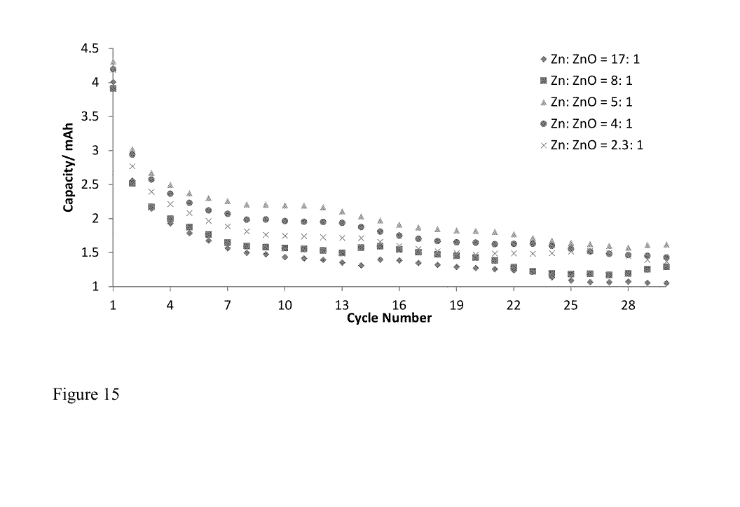

Different zinc to zinc oxide ratios were also tried to optimize the anode formulation. Zinc oxide was critical to inhibit gassing while it could be reduced back to zinc during charging as active material; while at the same time it may reduce the available amount of electrolyte. Cells with a Zn:ZnO ratio of 5:1 turned out to have the best rechargeability, followed closely by Zn:ZnO ratio of 4:1. Cells with higher amount of ZnO showed lower performance due to the low conductivity of ZnO; while with very low amount of ZnO, the rechargeability also turned out to be poor. The performance of cells with different Zn:ZnO ratio was shown in FIG. 15.

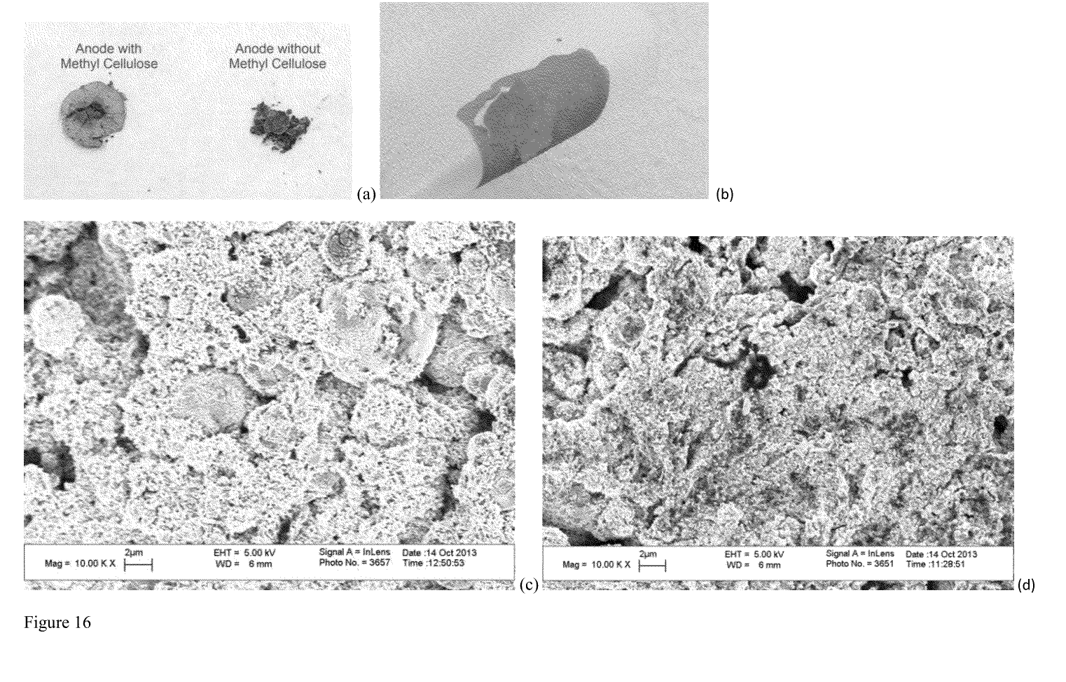

Effect of Cycle Time: Many have reported capacity fades in secondary alkaline cells. There have been different opinions on the mechanisms why the capacity of the cell decreased as the cycles go on: soluble zincate entering into MnO₂ lattice and shape change of anode. Hence MgO was added to cathode to block the zincate ions into MnO₂ region, while methyl cellulose was added into anode as gelling agent. After 10 s of cycles changes of anode material can be observed. FIG. 16 shows anode material after 30 cycles and parts of the anode formed hard shell with darker color, which has also been observed by other researchers.

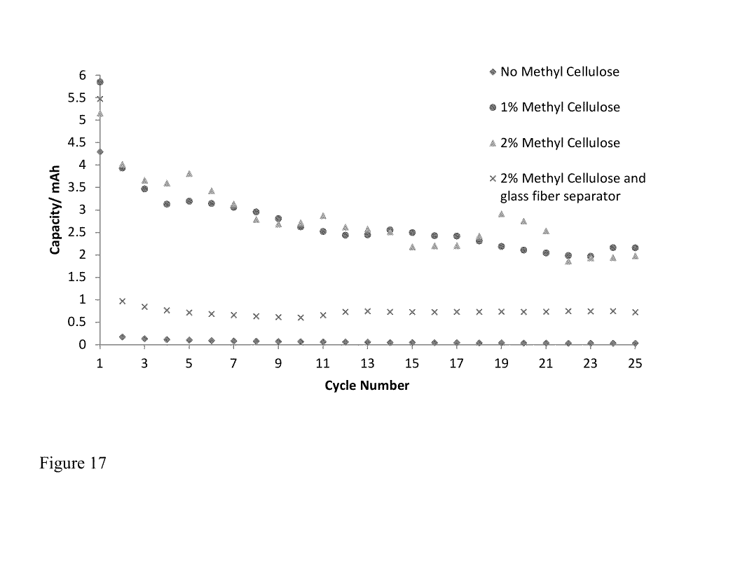

The SEM images of the light and dark parts of the anode have also been shown in FIG. 16. It is believed that such layer is less permeable to electrolyte and hence hinders further electrochemical reactions. With certain amount of gelling agent like methyl cellulose, the formation of this dark shell could be hindered and cell performance increased as shown in FIG. 17. However with more gelling agent in anode, the anode material became fragile, which compromised the flexibility. Another reason the cell ceased to work may relate to the failure of separator: this happened when traditional glass fiber separator was used but was overcome using copolymer separator (FIG. 17).

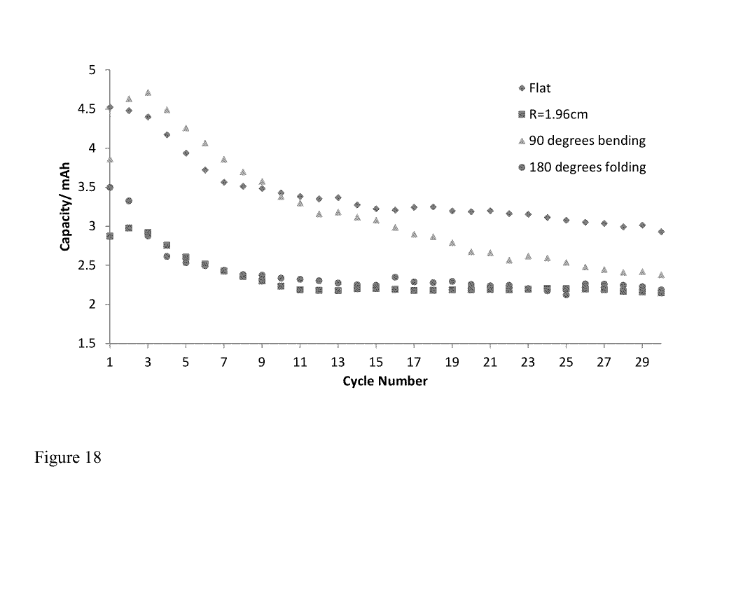

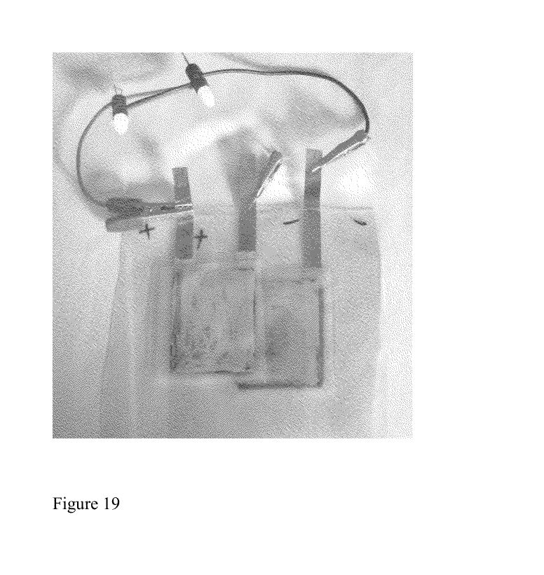

The actual flexible cell performance was shown in FIG. 18. Having been proved to be effective in primary batteries, the copolymer separator also worked in secondary batteries. The flexible cells remained functional under bending and even folding conditions. The cell performance can also be improved by using MnO₂ nanoparticles.^{[25,26]} The cells have an open circuit voltage of 1.5V, and with two cells connected in serial they can power up LED lights as shown in FIG. 19.

A flexible secondary alkaline battery has been fabricated. Purified multiwalled carbon nanotubes were found be effective conductive additives when combined with carbon black, considering both cathode performance and flexibility. Small amount of carbon nanotubes would also benefit anode. Polyvinyl alcohol-poly (acrylic acid) copolymer film not only works in primary alkaline cells but also in secondary ones. Since rechargeable alkaline batteries have been reported to work better for less deep discharges and frequent charge, it would be a good option to be connected with low cost organic solar cells. Printing techniques, like screen printing, can also be utilized in electrode fabrication.

### EXPERIMENTAL

### Primary batteries

The cathode paste was prepared by mixing electrolytic manganese dioxide powder (EMD, TRONOX, ≧92%, AB Grade), polyethylene oxide (PEO, Sigma Aldrich, Mv˜400,000) and conductive additive. Multiwalled carbon nanotubes (MWCNTs, purity 95%, diameter 20-30 nm, length 10-30 μm, Cheap Tubes Inc. Brattleboro, Vt., USA) were used as received, purified or functionalized prior to the electrode preparation. Other conductive additives including synthetic graphite (Sigma Aldrich, <20 micron) were used without further treatment. The purification and functionalization of CNTs was performed in a Microwave Accelerated Reaction System (Mode: CEM Mars) using method previously published by our laboratory. The chemical powders were mixed and then added into water which served as the solvent. The slurry was mixed for at least 30 min, followed by 30 min sonication using OMNI SONIC RUPTOR 250 ultrasonic homogenizer. Then the cathode slurry was stirred again to form a homogeneous cathode material. The typical cathode dry formulation in a flexible alkaline battery contains 82% w/w EMD, 8% w/w conductive additive and 10% w/w PEO binder. Formulations varied for those batteries fabricated under fixed modes to optimize the formulation.

The anode paste was prepared by mixing zinc powder (Sigma Aldrich, ≦10 μm, ≧98%), zinc oxide powder (Sigma Aldrich, ≧99%), PEO binder, Bismuth (III) oxide (Sigma Aldrich, 90-210 nm particle size, ≧99.8%) and conductive additive. The chemical powders were mixed, added into water, and then stirred to form a homogeneous anode paste. The typical anode dry formulation in a flexible alkaline battery contains 89% w/w zinc, 2% w/w ZnO, 2% w/w conductive additive, 3% w/w Bi₂O₃ and 4% w/w PEO binder. Formulations varied for the batteries fabricated under fixed mode to optimize the formulation.

The flexible electrodes were prepared by casting the electrode slurries onto the current collector, which was silver ink (CAIG Laboratories Inc.) pasted directly onto the substrate or carbon tape (NEM tape, Nis shin EMCO Ltd) coated with silver ink. Before casting the electrode material, the carbon tape was stuck to the adhesive side of polyethylene terephthalate PET film, coated with ethylene vinyl acetate copolymer (EVA) resin. The typical electrode area of a flexible battery was 4 cm×3 cm. The strips of copper foil stuck to the current collector served as electrode tabs. The electrodes are bendable as shown in FIG. 1.

A copolymer film made from polyvinyl alcohol (PVA, Sigma Aldrich, Mv˜130,000) and poly (acrylic acid) (PAA, Sigma Aldrich, Mv˜450,000) was used as the separator in the flexible battery. PAA was first dissolved in 0.26% KOH solution, with mass ratio 1:30, and stirred under 80° C. till all solid dissolved. After a sonication of 30 min, extra DI water was added along with PVA. The typical PVA:PAA mass ratio here was 2:1 to get a good balance between ionic conductivity and mechanical strength. The solution was stirred at 70° C. till PVA dissolves. Then after another 30 min sonication, the solution was again stirred for at least 12 hours, which was then left for at least 12 hours to remove the air and bubbles. The fluid was then casted onto a flat smooth surface and dried. After drying, the copolymer film was peeled from the surface and heated at 150˜170° C. for 50 min for crosslinking by ester linkage. Typical thickness of such a copolymer film is 0.2 mm.

After applying the electrode slurry onto the current collectors, the electrodes were allowed to dry at ˜60° C. for 30 minutes. The typical weights of the cathode and anode after drying were 0.315 and 0.64 g, respectively. The electrodes were assembled co-facially with the separator between them. Before assembling, the separator was soaked in electrolyte solution (9M KOH solution with 6% ZnO). The battery was thermally sealed in a laminator.

The electrochemical performances of different formulations were measured under fixed mode in Swagelok cells. In this case the electrode paste was casted directly onto the graphite rod current collectors (12.5 mm diameter) and dried. The typical weight of the cathode paste after drying was 0.03 g. For both “rigid” and flexible cells, the Zn anode was taken in excess in respect to MnO₂ cathode to maintain anode conductivity. Glass microfiber filters (Grade GF/A: 1.6 μm, Whatman) were used as separator in such Swagelok cells. In cases of cathode optimization, anode was fixed as 96% w/w zinc, 2% w/w ZnO and 2% w/w PEO binder; while in cases of anode optimization, cathode contains 84% w/w EMD, 6% w/w conductive additive and 10% w/w PEO binder.

The electrochemical performance of the battery was measured using MTI Battery Analyzer (Richmond, Calif.). For the measurement of the electrochemical performance under bending, the batteries were firmly attached over a cylindrical solid substrate with different diameters. Scanning electron microscope (SEM) images were collected on the LEO 1530 VP Scanning Electron Microscope. The surface resistances of composite electrodes were measured between two points at the distance of 1 cm with a Keithley digital multimeter.

### Secondary Batteries

The cathode paste was prepared by mixing electrolytic manganese dioxide powder (EMD, TRONOX, ≧92%, AB Grade), polyethylene oxide (PEO, Sigma Aldrich, Mv˜400,000) binder, magnesium oxide (Sigma Aldrich, 99.99%) and conductive additives. The conductive additives include synthetic graphite (Sigma Aldrich, <20 micron), multiwalled carbon nanotubes (MWCNTs, purity 95%, diameter 20-30 nm, length 10-30 μm, Cheap Tubes Inc. Brattleboro, Vt., USA), carbon black (Sigma Aldrich, <500 mn). All the other chemicals but MWCNTs were as used received, while the in some cases MWCNTs were purified or functionalized prior to the electrode preparation. The purification and functionalization of MWCNTs were performed in a Microwave Accelerated Reaction System (Mode: CEM Mars) using experimental procedures previously reported by our laboratory.^{[29]} After mixing the components in DI water, the paste was sonicated for at least 30 minutes using OMNI SONIC RUPTOR 250 ultrasonic homogenizer and then stirred for 20 hours to form homogenous slurry. The dry cathode contained 2.0% w/w MgO, 10% w/w PEO, and the rest being EMD and conductive additives. The EMD-conductive additive ratios in the cathode mixture were varied and subject to optimization.

The anode paste was prepared with zinc powder (Sigma Aldrich, ≦10 μm, ≧98%), PEO binder, zinc oxide powder (Sigma Aldrich, ≧99%), methyl cellulose (Sigma Aldrich, Mn˜40,000), Bismuth (III) oxide (Sigma Aldrich, 90-210 nm particle size, ≧99.8%) inhibitors, and conductive additive. The powders were mixed in the presence of DI water, and then stirred to form a homogeneous anode paste. Typically a dry anode contained 1% w/w methyl cellulose, 5% PEO and 2% w/w Bismuth (III) oxide. The amount of zinc, zinc oxide, conductive additives were subject to optimization.

A polyvinyl alcohol (PVA, Mowiol 18-88, Sigma Aldrich, Mv˜130,000)-poly (acrylic acid) (PAA, Sigma Aldrich, Mv˜450,000) copolymer separator was fabricated and used as the separator as previously reported.^{[16]} Before use, the separator was soaked in the electrolyte for 2 hours and cut into right sizes. In the flexible cell a typical separator after soaking and cutting was 5 cm×4 cm in size.

Swagelok-type cells using graphite rod current collectors were assembled to optimize the electrode formulation. During anode optimization, the cathode was fixed as 80% w/w EMD, 2% w/w MgO, 8% w/w MWCNTs, 10% PEO; as to cathode optimization, anode contained 72% w/w Zn, 18% w/w ZnO, 5% w/w PEO, 2% w/w MWCNTs, 1% w/w methyl cellulose and 2% w/w Bi₂O₃. The typical weights of the cathode and anode after drying were 0.03 and 0.05 g, respectively. 9 M KOH solution with 6% ZnO was used as electrolyte.

For flexible cells, electrodes were prepared by casting the electrode slurry onto the silver paste current collector on adhesive side of polyethylene terephthalate PET film coated with ethylene vinyl acetate copolymer (EVA) resin. The typical electrode area was 4 cm×3 cm. Copper foil strips stuck to the carbon tape served as electrode tabs. After applying the slurry onto the current collector, the electrodes were allowed to dry at ˜50° C. for 30 minutes. The last 5 minutes of drying was processed under vacuum (9.893 kPa). The drying was complete with no residual water. The typical weights of the cathode and anode after drying were 0.06 and 0.125 g, respectively. The battery was finally thermally sealed. Structure of the battery and flexible electrodes after drying have been shown in FIG. 1.

Scanning electron microscope (SEM) images were collected on a LEO 1530 VP Scanning Electron Microscope. The electrochemical performances of the cells were measured by discharging and charging under constant current modes using a MTI Battery Analyzer (Richmond, Calif.). The fixed Swagelok-type cells were discharges at 1.478 mA to 0.9V and charged at 2.956 mA to 2V; while the flexible ones were discharged and charged at 4 mA and 8 mA respectively. The flexible batteries were also firmly attached over solid substrates of different shapes like and tested to examine electrochemical performance under bending conditions.

Although the systems and methods of the present disclosure have been described with reference to exemplary embodiments thereof, the present disclosure is not limited thereby. Indeed, the exemplary embodiments are implementations of the disclosed systems and methods are provided for illustrative and non-limitative purposes. Changes, modifications, enhancements and/or refinements to the disclosed systems and methods may be made without departing from the spirit or scope of the present disclosure. Accordingly, such changes, modifications, enhancements and/or refinements are encompassed within the scope of the present invention.

1. A flexible a battery comprising nanocarbon enhanced composite electrodes consisting of an anode and a cathode and a separator.

2. A flexible battery which is an alkaline battery.

3. A flexible alkaline battery comprising carbon nanotubes (CNT enhanced composite electrodes consisting of an anode and a cathode and a polyvinyl alcohol (PVA)-poly (acrylic acid) (PAA) copolymer separator.

4. The flexible alkaline battery of claim 1 wherein the CNTs are purified.

5. The flexible alkaline battery of claim 1 which is a primary alkaline battery.

6. The flexible alkaline battery of claim 3 wherein the cathode comprises electrolytic manganese dioxide powder, polyethylene oxide and multiwalled carbon nanotubes.

7. The flexible alkaline battery of claim 4 wherein the anode comprises of zinc, zinc oxide, conductive additive, bismuth III oxide and polyethylene oxide.

8. The flexible alkaline battery of claim 1 which is a secondary alkaline battery.

9. The flexible alkaline battery of claim 6 wherein the cathode comprises electrolytic manganese dioxide powder, magnesium oxide, polyethylene oxide and one or more conductive additives selected from the group of synthetic, multiwalled carbon nanotubes, and carbon black.

10. The flexible alkaline battery of claim 7 wherein the anode comprises zinc powder, zinc oxide powder, methyl cellulose, Bismuth (III) oxide inhibitors, and one or more conductive additives selected from the group of synthetic, multiwalled carbon nanotubes, and carbon black.
